(19) United States
(12) Patent Application Publication
(10) Pub. No.: US 2025/0157372 A1
(43) Pub. Date: May 15, 2025

(54) DISPLAY DEVICE

(71) Applicant: SHARP KABUSHIKI KAISHA, Sakai City, Osaka (JP)

(72) Inventors: HIROYUKI FURUKAWA, Sakai City, Osaka (JP); MASAFUMI UENO, Sakai City, Osaka (JP); Chie TORIDONO, Sakai City, Osaka (JP); MASAAKI MORIYA, Sakai City, Osaka (JP)

(21) Appl. No.: 18/839,568

(22) PCT Filed: Apr. 22, 2022
(86) PCT No.: PCT/JP2022/018538

§ 371 Date: Aug. 19, 2024

(51) Int. Cl. G09G 3/00; G09G 3/3233

(52) U.S. Cl. CPC G09G 3/006; G09G 3/3233; G09G 2300/0842; G09G 2320/0295; G09G 2320/046; G09G 2330/021; G09G 2330/12

(57) ABSTRACT

A display device includes a control unit obtaining, at time intervals, degradation information on a plurality of subpixels, and setting a data signal to be supplied to each of the subpixels in accordance with the degradation information and determining, from the degradation information, presence or absence of a short circuit between a first power supply unit and a second power supply unit.

### TECHNICAL FIELD

The present invention relates to a display device.

### BACKGROUND ART

In a display device, a narrow space between a first power supply unit and a second power supply unit might cause a short circuit between the first power supply unit and the second power supply unit because of, for example, an external impact and a stress.

Patent Document 1 discloses a technique to determine the presence or absence of a short circuit created in the display device.

### CITATION LIST

### Patent Literature

[Patent Document 1] Japanese Unexamined Patent Application Publication No. 2007-248902

### SUMMARY OF INVENTION

### Technical Problem

A current flowing in a display device could vary depending on, for example, a temperature and a display pattern of the display device. Hence, it is never easy to determine the presence or absence of a short circuit created in the display device through detection of a current, because setting a threshold value is difficult.

### Solution to Problem

A display device according to an aspect of the present disclosure includes: a plurality of subpixels each including a light-emitting element; a first power supply unit and a second power supply unit electrically connected to each of the subpixels; and a control unit configured to obtain, at time intervals, degradation information on the plurality of subpixels, and (1) to set a data signal to be supplied to each of the subpixels in accordance with the degradation information and (2) to determine, from the degradation information, presence or absence of a short circuit between the first power supply unit and the second power supply unit.

### Advantageous Effects of Invention

An aspect of the present disclosure can easily determine the presence or absence of a short circuit between a first power supply unit and a second power supply unit.

### BRIEF DESCRIPTION OF DRAWINGS

FIG. 1 is a block diagram illustrating a schematic configuration of a display device according to a first embodiment of the present disclosure.

FIG. 2 is a circuit diagram illustrating a configuration of a subpixel of the display device illustrated in FIG. 1.

FIG. 3 is a graph illustrating voltage-current characteristics of a first transistor.

FIG. 4 is a flowchart showing an operational flow of a control unit.

FIG. 5 shows two graphs, which are different from FIG. 3, illustrating voltage-current characteristics of the first transistor.

FIG. 6 is a schematic diagram illustrating the display device according to the first embodiment of the present disclosure.

FIG. 7 is a block diagram illustrating a schematic configuration of a display device according to a second embodiment of the present disclosure.

FIG. 8 shows operation of a control unit of the display device illustrated in FIG. 7.

### DESCRIPTION OF EMBODIMENTS

Embodiments of present disclosure will be described below. For convenience in description, like reference signs designate members having identical functions throughout the Description. These members might not be elaborated upon repeatedly.

### First Embodiment

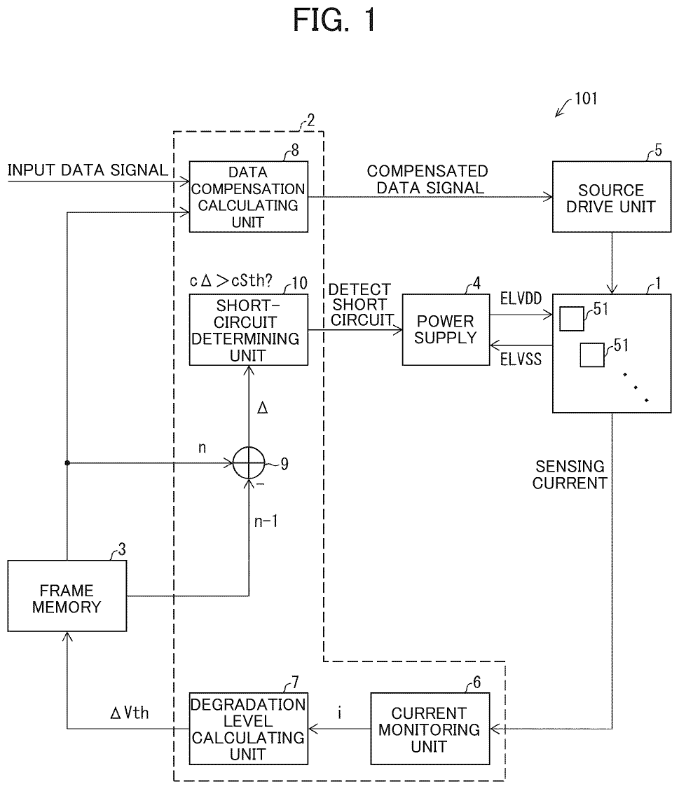

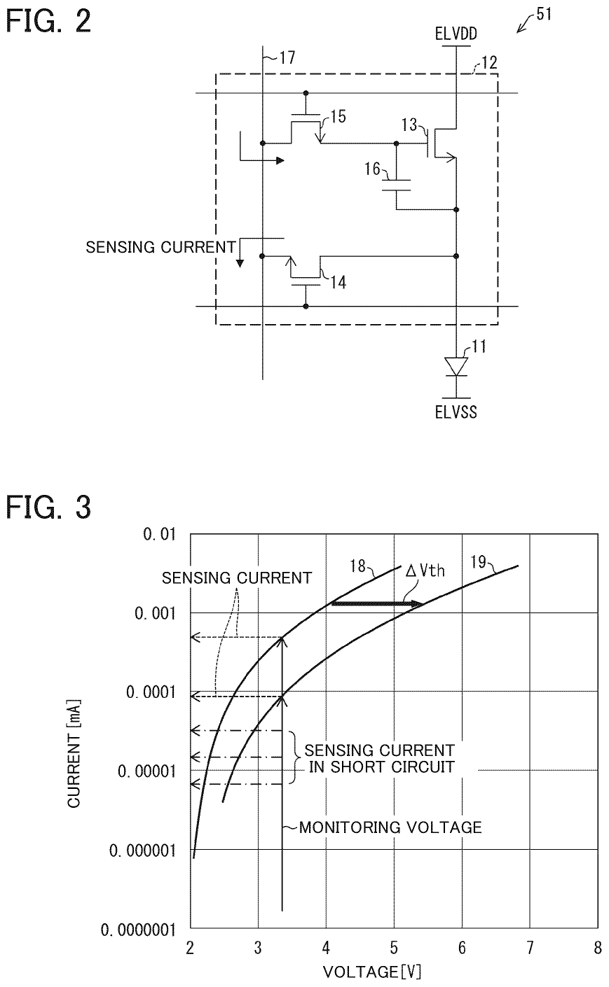

FIG. 1 is a block diagram illustrating a schematic configuration of a display device 101 according to a first embodiment of the present disclosure. FIG. 2 is a circuit diagram illustrating a configuration of a subpixel 51 of the display device 101. FIG. 3 is a graph illustrating voltage (a horizontal axis)-current (a vertical axis) characteristics of a first transistor 13.

The display device 101 includes: a display panel 1; a control unit 2; a frame memory 3; a power supply 4; a source drive unit 5; and a gate drive circuit (not-shown). The control unit 2 includes: a current monitoring unit 6; a degradation level calculating unit 7; a data compensation calculating unit 8; a difference obtaining unit 9; and a short-circuit determining unit 10.

The display panel 1 has a plurality of the subpixels 51. Each of the plurality of subpixels 51 has: a light-emitting element 11; and a subpixel circuit 12 that drives the light-emitting element 11. The subpixel circuit 12 has: a first transistor 13; a second transistor 14; a third transistor 15; and a capacitor 16. Examples of the light-emitting element 11 include an organic light-emitting diode (an OLED) and a quantum-dot light-emitting diode (a QLED).

In the display panel 1, the plurality of subpixels 51 are arranged in, for example, a matrix. The display panel 1 includes, for example, data signal lines (a plurality of data signal lines) 17 provided for the respective columns of the plurality of subpixels 51. Each of the subpixels 51 includes the first transistor 13 connecting to the light-emitting element 11. Each subpixel 51 includes the second transistor 14 connecting to the first transistor 13 and to one of the plurality of data signal lines 17 (a data signal line 17 corresponding to the subpixel 51).

Each subpixel 51 is electrically connected to a first power supply unit ELVDD and to a second power supply unit ELVSS. The first power supply unit ELVDD and the second power supply unit ELVSS are each supplied with power from the power supply 4. The first power supply unit ELVDD is a generic name for a portion supplied with a high-potential (e.g., 12 V) power. The second power supply unit ELVSS is a generic name for a portion supplied with a low-potential (e.g., 2 V) power. The first transistor 13 is connected to the first power supply unit ELVDD.

The control unit 2 obtains, at time intervals, degradation information on the plurality of subpixels 51, and (1) sets a data signal to be supplied to each of the subpixels 51 in accordance with the degradation information.

In the display device 101, each of the subpixel circuits 12 provided to the display panel 1 includes the second transistor 14. In each subpixel circuit 12, the second transistor 14 turns ON, and a sensing current, corresponding to a monitoring voltage written by the third transistor 15 to the first transistor 13, flows into a data signal line 17 corresponding to the subpixel circuit 12. The sensing current can be read for each of the plurality of subpixels 51.

The current monitoring unit 6 obtains the sensing current from each of the plurality of subpixels 51. The degradation level calculating unit 7 obtains a degradation level indicated in the degradation information on the plurality of subpixels 51, in accordance with a sensing current value i indicated with the sensing current for each of the first transistors 13. The frame memory 3 stores the degradation level. The data compensation calculating unit 8 receives an input data signal for each of the plurality of subpixels 51, and reads the degradation level from the frame memory 3. The data compensation calculating unit 8 corrects the input data signal in accordance with the degradation level, and sets a compensated data signal to be supplied to each of the plurality of subpixels 51. Hence, the data compensation calculating unit 8 sets the data signal to be supplied to each subpixel 51, in accordance with the degradation information. The source drive unit 5 supplies the compensated data signal to each of the plurality of subpixels 51. The plurality of subpixels 51 display an image, in accordance with the compensated data signals supplied to the subpixels 51 themselves.

A characteristic 18 is an example of a characteristic of the first transistor 13 in an initial stage (before degradation). A characteristic 19 is an example of the first transistor 13 after degradation. The characteristic 19 exhibits a smaller current value for the same voltage than the characteristic 18. As the degradation of the first transistor 13 progresses, the current value for the same voltage decreases. For each of the subpixels 51, the data compensation calculating unit 8 corrects the input data signal and sets the data signal, so as to compensate for the decrease in the current value for the same voltage. When the degradation information is obtained at time intervals, both of the characteristics 18 and 19 can be obtained.

As to each subpixel 51, the sensing current is correlated with a current value of the first transistor 13. Hence, for each of the plurality of subpixels 51, the degradation information, and consequently the degradation level indicated in the degradation information, can be obtained from the sensing current. The control unit 2 obtains the degradation level. The degradation level is a shift amount ΔVth of an ON voltage of the first transistor 13. The control unit 2 calculates the shift amount ΔVth from the sensing current flowing from the second transistor 14 to one of the plurality of data signal lines 17.

When a short circuit is created between the first power supply unit ELVDD and the second power supply unit ELVSS, the first transistor 13 does not perform a desired amplifying operation. Thus, the sensing current gives an abnormal value (a value smaller than a normal value in most cases). However, because the degree of abnormality as a value of the sensing current varies depending on the state of the short circuit, it is never easy to determine the presence or absence of the short circuit, using a fixed reference current value.

The control unit 2 obtains, at time intervals, degradation information on the plurality of subpixels 51, and (2) determines, from the degradation information, the presence or absence of a short circuit between the first power supply unit ELVDD and the second power supply unit ELVSS.

The control unit 2 calculates, for each of the subpixels 51, a difference Δ between a degradation level n indicated in the present (the current) degradation information and a degradation level n−1 indicated in the previous (the past) degradation information, and detects an abnormal subpixel for which the difference Δ exceeds a threshold value E. The control unit 2 calculates the difference between the degradation level indicated in the degradation information at a certain time point and the degradation level indicated in the degradation information at a previous time point, and uses the difference to determine the presence or absence of a short circuit between the first power supply unit ELVDD and the second power supply unit ELVSS. Burn-in degradation of the display panel 1 does not progress significantly in a short time. That is why this characteristic is utilized. If the total number of abnormal subpixels (corresponding to a count value cΔ) exceeds a first reference value cSth, the control unit 2 determines the presence of a short circuit between the first power supply unit ELVDD and the second power supply unit ELVSS.

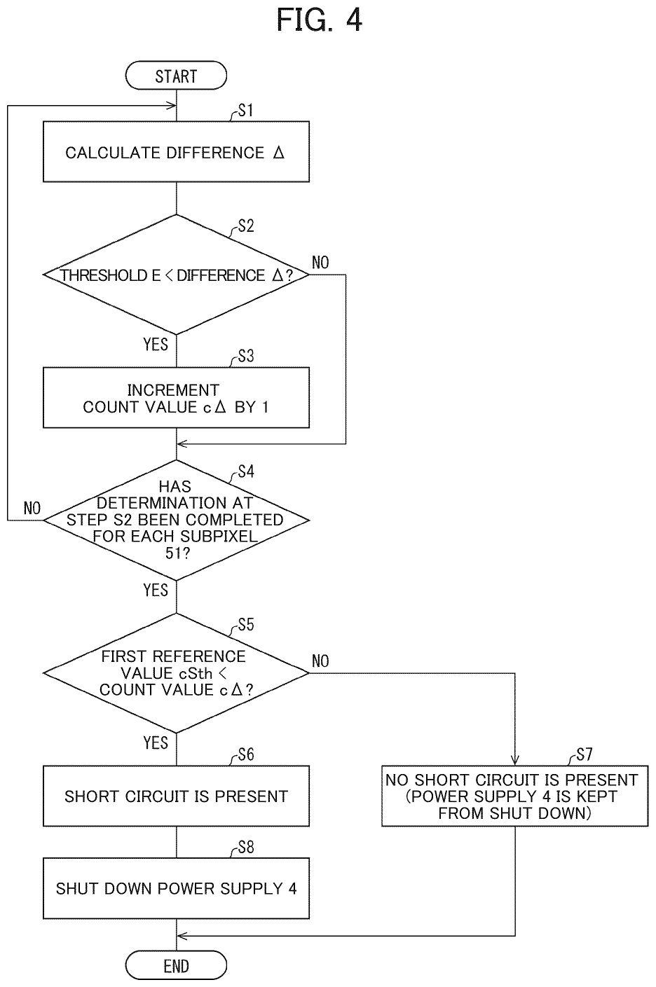

FIG. 4 is a flowchart showing an operational flow of the control unit 2. The flowchart includes Steps S1 to S8.

The control unit 2 carries out a set of Steps S1 to S3 for each of the subpixels 51.

At Step S1, the difference obtaining unit 9 reads, from the frame memory 3, the degradation level n indicated in the present degradation information and the degradation level n−1 indicated in the previous degradation information, and calculates the difference Δ between the degradation levels n and n−1.

At Step S2, the short-circuit determining unit 10 determines whether the difference Δ exceeds the threshold value E. If the difference Δ exceeds the threshold E (Step S2: YES), Step S3 is carried out. If the difference Δ does not exceed the threshold E (Step S2: NO), Step S3 is skipped and Step S4 is carried out.

At Step S3, the short-circuit determining unit 10 increments the count value cΔ by 1. The count value cΔ increments by 1 every time the difference Δ exceeds the threshold value E, in other words, for each abnormal subpixel. At Step S3, the count value cΔ counts the number of abnormal subpixels.

At Step S4, the short-circuit determining unit 10 determines whether the determination at Step S2 has been completed for each subpixel 51. If the determination has been completed (Step S4: YES), Step S5 is carried out. If the determination has not been completed (Step S4: NO), the processing returns to Step S1 so that a subpixel 51 with the set of Steps S1 to S3 uncompleted undergoes the set.

At Step S5, the short-circuit determining unit 10 determines whether the count value cΔ exceeds the first reference value cSth. If the count value cΔ exceeds the first reference value cSth (Step S5: YES), Step S6 is carried out. If the count value cΔ does not exceed the first reference value cSth (Step S5: NO), Step S7 is carried out. The count value cΔ, which is compared with the first reference value cSth at Step S5, is obtained when the number of abnormal subpixels is counted out of the subpixels 51. Hence, the count value cΔ represents a total number of the abnormal subpixels.

At Step S6, the short-circuit determining unit 10 determines the presence of a short circuit between the first power supply unit ELVDD and the second power supply unit ELVSS. At Step S8 (if the presence of the short circuit is determined), the short-circuit determining unit 10 stops supplying at least one of the high-potential power to the first power supply unit ELVDD or the low-potential power to the second power supply unit ELVSS. For this purpose, for example, the short-circuit determining unit 10 shuts down the power supply 4.

At Step S7, the short-circuit determining unit 10 determines that no short circuit is present between the first power supply unit ELVDD and the second power supply unit ELVSS. Hence, the short-circuit determining unit 10 continues to supply both the high-potential power supply and the low-potential power supply (i.e., the short-circuit determining unit 10 keeps the power supply 4 from shutting down).

The sensing current value i, which is sequentially read from the current monitoring unit 6 for each of the subpixels 51 (see FIG. 1), is converted by the degradation level calculating unit 7 into the shift amount ΔVth (see FIG. 1) of the ON voltage of the first transistor 13. The shift amount ΔVth is stored in the frame memory 3.

The shift amount ΔVth of each subpixel 51 is read from the frame memory 3 for each frame period. In accordance with the shift amount ΔVth, the data compensation calculating unit 8 carries out calculation for compensation. The compensated data signal is sent to the source drive unit 5 for displaying an image on the display panel 1. Such an operation compensates for a decrease in luminance caused by burn-in degradation of the display panel 1.

Meanwhile, read from the frame memory 3 are the degradation level n indicated in the present degradation information to be used for the compensation calculation and the degradation level n−1 indicated in the previous degradation information. A difference is calculated for each of the subpixels 51 between the degradation levels indicated in the degradation information at different time points (i.e., the difference Δ is obtained).

A result of the difference calculation is compared with a predetermined threshold value E, and how many times the difference Δ exceeds the threshold value E is counted (i.e., the count value cΔ is obtained).

If the count value cΔ exceeds the first reference value cSth (if the number of subpixels 51, which exhibit a change in degradation level that cannot be observed in normal degradation, exceeds a certain value), the short-circuit determining unit 10 determines that a short circuit is found between the first power supply unit ELVDD and the second power supply unit ELVSS, and shuts down the power supply 4.

The control unit 2 calculates, for each of the subpixels 51, the difference Δ between the degradation level n indicated in the present degradation information and the degradation level n−1 indicated in the previous degradation information. Here, the threshold value E compared with the difference Δ may be 0.5 to 2 times the degradation level n−1 indicated in the previous degradation information. This is because, if the display device 101 is in normal use, the difference Δ cannot normally exceed the threshold value E.

When the degradation level n indicated in the present degradation information exceeds a value 1.5 times to 3 times the degradation level n−1 indicated in the previous degradation information, the degradation level n may be a criterion for determining that the corresponding subpixel 51 is an abnormal subpixel.

The first power supply unit ELVDD and the second power supply unit ELVSS can be branched and routed for each of a plurality of columns in the display panel 1. Here, at least approximately 100 subpixels 51 around the short circuit between the first power supply unit ELVDD and the second power supply unit ELVSS can be abnormal subpixels. Hence, the first reference value cSth may be 100 or more and 1000 or less. Note that, preferably, the first reference value cSth is set appropriately in accordance with how the first power supply unit ELVDD and the second power supply unit ELVSS are provided in the display device 101.

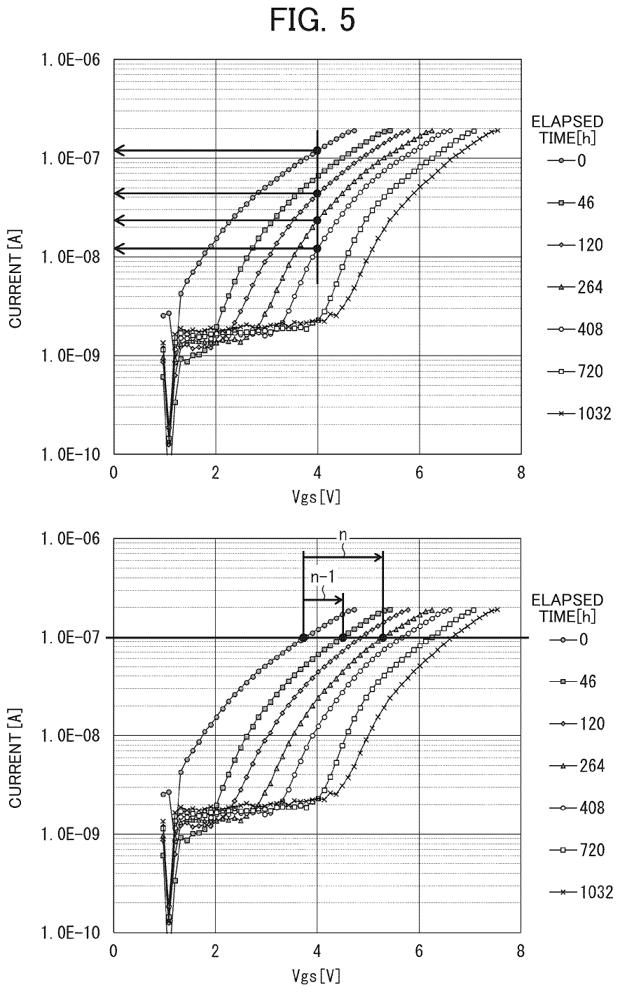

FIG. 5 shows two graphs, which are different from FIG. 3, illustrating voltage (the horizontal axis)-current (the vertical axis) characteristics of the first transistor 13. FIG. 5 shows results of monitoring the voltage-current characteristics of the first transistor 13 in a subpixel 51 at every elapsed time period when White 255 (white) is displayed under an acceleration test environment at 85° C.

For example, when the first transistor 13 has a gate-source voltage Vgs of 4 [V], a current read from the first transistor 13 is 120 [nA] at an initial stage (an elapsed time period of 0 hours), 44 [nA] after an elapsed time period of 120 hours, 24 [nA] after an elapsed time period of 264 hours, and 12 [nA] after an elapsed time period of 408 hours. As can be seen, the current read from the first transistor 13 decreases with the passage of time.

Whereas, when the current value 90 [nA] is set as a reference, the shift amount ΔVth, which is a degradation amount of the voltage Vgs from the initial stage, is approximately 0.9 [V] after an elapsed time period of 46 hours corresponding to the degradation level n−1 indicated in the previous degradation information. The two graphs in FIG. 5 show that a relationship of ΔVth=approximately 1.8 [V] holds after an elapsed time period of approximately 264 hours corresponding to the degradation level n indicated in the present degradation information.

Burn-in degradation of the display panel 1 progresses slowly with time. Even if a measurement error, found at the time of monitoring because of such an influence as noise, is taken into consideration, such a remarkable difference from the immediately preceding shift amount ΔVth does not appear in the periodic current monitoring. In contrast, if a short circuit is created between the first power supply unit ELVDD and the second power supply unit ELVSS, the first transistor 13 does not perform a normal amplifying operation, and the amount of read current significantly decreases. As a result, the calculated amount of degradation is seemingly extremely large. Then, in consideration of a manufacturing process of the display panel 1, design conditions of the display panel 1 such as widths of various wires, and a degree of the short circuit, the threshold value E may be 0.5 times or more of the degradation level n−1 indicated in the previous degradation information, or may be the same as the degradation level n−1 indicated in the previous degradation information.

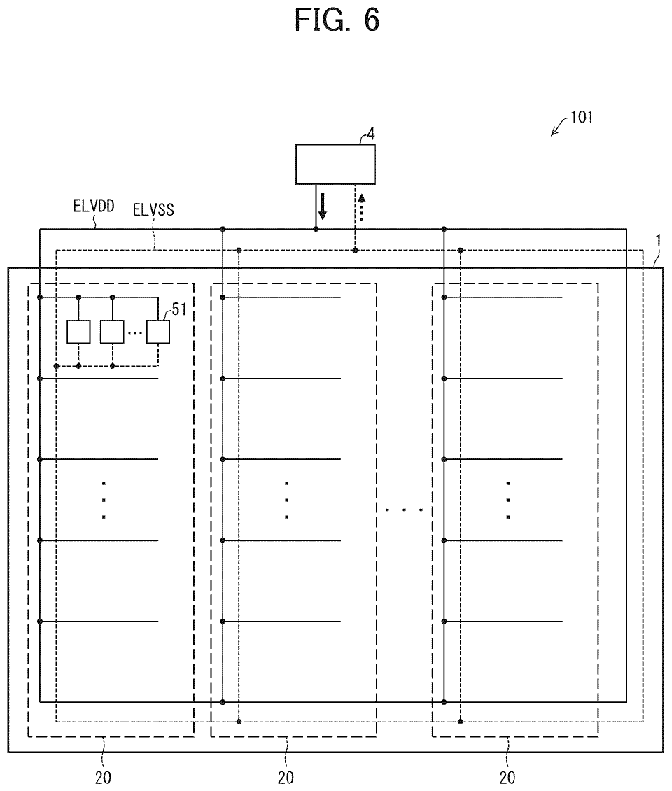

FIG. 6 is a schematic diagram illustrating the display device 101 according to the first embodiment of the present disclosure.

The first power supply unit ELVDD includes a plurality of power supply lines electrically connected. Each of the power supply lines is connected to two or more of the plurality of subpixels 51.

The second power supply unit ELVSS includes a power supply electrode. This power supply electrode is connected to two or more of the plurality of subpixels 51. The power supply electrode functions as a cathode of the light-emitting element 11 (see FIG. 2).

The plurality of subpixels 51 are arranged over a plurality of blocks 20. If the number of abnormal subpixels in the blocks 20 exceeds a second reference value, the presence of a short circuit may be determined between the first power supply unit ELVDD and the second power supply unit ELVSS. Preferably, the second reference value is set appropriately in accordance with how the first power supply unit ELVDD and the second power supply unit ELVSS are provided in the display device 101.

The first power supply unit ELVDD and the second power supply unit ELVSS are distributed in the display panel 1. Specifically, an output of the power supply 4 is distributed over the plurality of blocks 20 for each of several tens to several hundreds of subpixel columns. If a short circuit is created between the first power supply unit ELVDD and the second power supply unit ELVSS in a certain block 20, a plurality of subpixels 51 located around the short circuit in the block 20 are significantly influenced simultaneously. (The influence is small in a distant block 20 because of wiring resistance.) This characteristic is used to count the number of subpixels 51 for which the difference Δ exceeds the threshold value E. If the number exceeds a specified number, the presence of the short circuit is determined. Conditions for the determination may additionally include the number of counts in the block 20.

If the first transistor 13 and/or the second transistor 14 in a subpixel 51 break/breaks down, the sensing current exhibits abnormality only in the subpixel 51. Hence, if a three-digit first reference value cSth is set for the entire display panel 1, the breakdown and the short circuit can be distinguished from each other.

Note that if a monitor line, a data signal line, or a gate signal line is broken, (or causes a leakage together with an adjacent line of the same type), the shift amounts ΔVth simultaneously take abnormal values in the same row and/or the same column in the display panel 1. Hence, other than the condition that the count value cΔ exceeds the first reference value cSth, it is more reliable to set another condition that subpixels 51 (abnormal subpixels), for which the difference Δ exceeds the threshold value E, are found over a plurality of columns and/or a plurality of rows.

### Second Embodiment

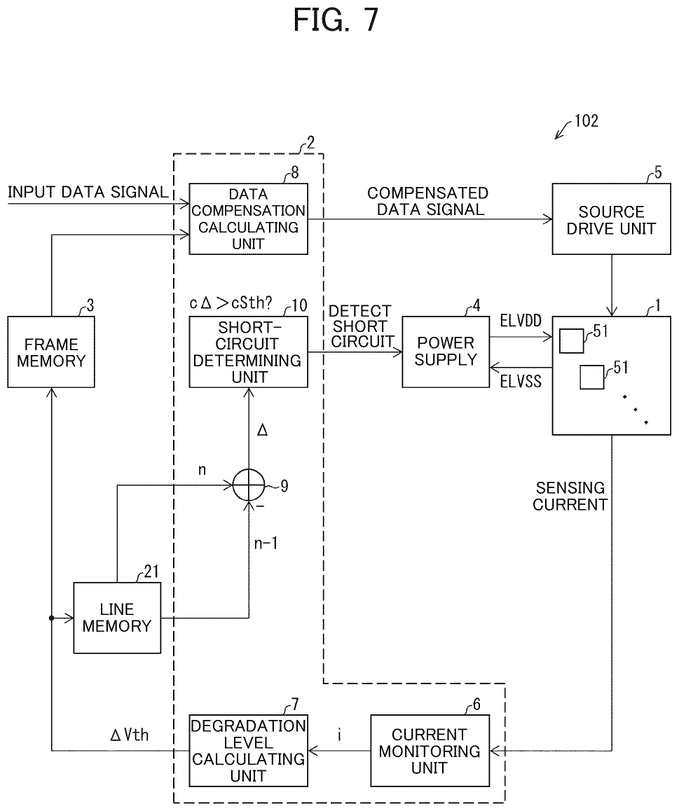

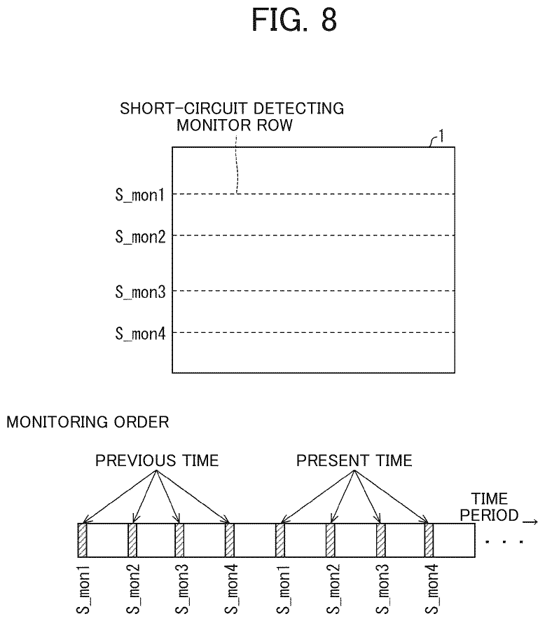

FIG. 7 is a block diagram illustrating a schematic configuration of a display device 102 according to a second embodiment of the present disclosure. FIG. 8 shows an operation of the control unit 2 of the display device 102.

The display device 102 is different from the display device 101 in that the display device 102 includes a line memory 21. The line memory 21 stores a degradation level indicated in degradation information on the plurality of subpixels 51. The difference obtaining unit 9 reads, from the line memory 21, a degradation level n indicated in the present degradation information and a degradation level n−1 indicated in the previous degradation information.

In the display device 102, the control unit 2 determines the presence or absence of a short circuit between the first power supply unit ELVDD and the second power supply unit ELVSS, every time obtaining degradation information on a predetermined number of subpixels 51 among the plurality of subpixels 51.

In the display device 101, the data to be used for determining the short circuit between the first power supply ELVDD and the second power supply ELVSS is read from the frame memory 3. However, in order to obtain a difference in degradation level for the number of subpixels 51 of one screen, it is necessary to update all the degradation level data of the one screen.

When the monitoring operation interrupts the display operation, the number of rows to be monitored within one frame period has a limit (an upper limit). Hence, it could take several tens of seconds or more to complete monitoring of the one screen. That is, the short circuit cannot be detected for a maximum of several tens of seconds since creation of the short circuit between the first power supply unit ELVDD and the second power supply unit ELVSS.

Hence, the display device 102 sets short-circuit detecting monitor rows S_mon1 to S_mon4. An interruption is made once every five rows in the normal current monitoring operation, and the current is monitored for the monitor rows S_mon1 to S_mon4. Thus, the time required for the degradation level n−1 indicated in the previous degradation information and the degradation level n indicated in the present degradation information to be equal to each other is the time when the monitoring operation is completed for 43 ((1+5)×7+1=43) rows. If the monitoring operation is performed for one row per frame, the short circuit can be determined at intervals of 0.8 seconds at 60 Hz per frame.

Here, the time required for the normal monitoring operation is increased by 20%; however, this is no problem as a cycle for understanding the degradation state. Furthermore, the number and selected positions of short-circuit detecting monitor rows, and the interruption intervals, shall not be limited to the above-described examples.

A plurality of the first power supply units ELVDD and/or a plurality of the second power supply units ELVSS run in the display panel 1, and branch to each of the subpixels 51. Hence, when a short circuit is created in a position between the first power supply unit ELVDD and the second power supply unit ELVSS, the short circuit also influences a short-circuit detecting monitor row located away from the short circuit. Therefore, the number of short-circuit detecting monitor rows does not have to be increased more than necessary.

### Overview

An external compensation system reads degradation information on the subpixels 51 from the display panel 1. The degradation information is used to determine a short circuit between the first power supply unit ELVDD and the second power supply unit ELVSS, and the power supply 4 is shut down as necessary.

Periodically, the degradation information on the subpixels 51 is read. Previously read degradation information and presently read degradation information are compared for each of the subpixels 51.

Thanks to the comparison, an overcurrent (i.e., a short circuit leakage) is determined. A criterion for the determination is set to a value sufficiently small to an extent that the overcurrent is not created in the normal degradation (more than 1.5 times to 3 times (e.g., 2 times) the previous shift amount ΔVth). In the normal burn-in degradation, no large difference is observed between the previous degradation information and the present degradation information (because the degradation progresses relatively slowly). That is why abnormality can be easily detected.

If unexpected degradation is not created, exceeding the expected previous criterion for determination, the degradation shall not be determined as a short circuit between the first power supply unit ELVDD and the second power supply unit ELVSS.

The unexpected degradation is interpreted as a defect and/or a breakdown of a transistor and/or a wire of a subpixel 51, and is not created in many subpixels 51. Note that such a defect and/or a breakdown, and a minute short-circuit leakage creates abnormality, and the abnormality influences subpixels 51 around the abnormality. Hence, when the number of the subpixels 51, for which the difference Δ exceeds a predetermined value (the threshold value E), exceeds a certain value (the first reference value cSth), creation of a short circuit is determined between the first power supply unit ELVDD and the second power supply unit ELVSS. Such a feature makes it possible to cope with an erroneous determination due to unexpected degradation.

### Summary

A display device according to a first aspect of the present disclosure includes: a plurality of subpixels each including a light-emitting element; a first power supply unit and a second power supply unit electrically connected to each of the subpixels; and a control unit configured to obtain, at time intervals, degradation information on the plurality of subpixels, and (1) to set a data signal to be supplied to each of the subpixels in accordance with the degradation information and (2) to determine, from the degradation information, presence or absence of a short circuit between the first power supply unit and the second power supply unit.

In the display device of a second aspect of the present disclosure according to the first aspect, the control unit calculates, for each of the subpixels, a difference between a degradation level indicated in current degradation information and a degradation level indicated in past degradation information, and detects an abnormal subpixel for which the difference exceeds a threshold value.

In the display device of a third aspect of the present disclosure according to the second aspect, if a total number of abnormal subpixels exceeds a first reference value, the presence of the short circuit is determined.

In the display device of a fourth aspect of the present disclosure according to the second aspect, the plurality of subpixels are arranged over a plurality of blocks, and if a number of abnormal subpixels in the blocks exceeds a second reference value, the presence of the short circuit is determined.

In the display device of a fifth aspect of the present disclosure according to the second aspect, the control unit determines the presence or absence of the short circuit, every time obtaining degradation information on a predetermined number of subpixels among the plurality of subpixels.

In the display device of a sixth aspect of the present disclosure according to the second aspect, each of the subpixels includes a first transistor connecting to the light-emitting element, and the degradation level is a shift amount of an ON voltage of the first transistor.

In the display device of a seventh aspect of the present disclosure according to the first aspect, the first power supply unit includes a plurality of power supply lines electrically connected, and each of the power supply lines is connected to two or more of the plurality of subpixels.

In the display device of an eighth aspect of the present disclosure according to the first aspect, the second power supply unit includes a power supply electrode, and the power supply electrode is connected to two or more of the plurality of subpixels.

In the display device of a ninth aspect of the present disclosure according to the eighth aspect, the power supply electrode functions as a cathode of the light-emitting element.

The display device of a tenth aspect of the present disclosure according to the sixth aspect further includes a plurality of data signal lines, and each of the subpixels includes a second transistor connected to the first transistor and to one of the plurality of data signal lines.

In the display device of an eleventh aspect of the present disclosure according to the tenth aspect, the first transistor is connected to the first power supply unit.

In the display device of a twelfth aspect of the present disclosure according to the tenth aspect, the control unit calculates the shift amount from a sensing current flowing from the second transistor to one of the plurality of data signal lines.

In the display device of a thirteenth aspect of the present disclosure according to the second aspect, the control unit calculates, for each of the subpixels, a difference between a degradation level indicated in present degradation information and a degradation level indicated in previous degradation information, and the threshold value is 0.5 to 2 times the degradation level indicated in the previous degradation information.

In the display device of a fourteenth aspect of the present disclosure according to any one of the first to thirteenth aspects, the first power supply unit is supplied with a high-potential power and the second power supply unit is supplied with a low-potential power.

In the display device of a fifteenth aspect of the present disclosure according to the fourteenth aspect, if the presence of the short circuit is determined, the control unit stops supplying at least one of the high-potential power or the low-potential power.

The present disclosure shall not be limited to the embodiments described above, and can be modified in various manners within the scope of claims. The technical aspects disclosed in different embodiments are to be appropriately combined together to implement another embodiment. Such an embodiment shall be included within the technical scope of the present disclosure. Moreover, the technical aspects disclosed in each embodiment may be combined together to achieve a new technical feature.

### REFERENCE SIGNS LIST

1 Display Panel
2 Control Unit
3 Frame Memory
4 Power Supply
5 Source Drive Unit
6 Current Monitoring Unit
7 Degradation Level Calculating Unit
8 Data Compensation Calculating Unit
9 Difference Obtaining Unit
10 Short-Circuit Determining Unit
11 Light-Emitting Element
12 Subpixel Circuit
13 First Transistor
14 Second Transistor
15 Third Transistor
16 Capacitor
17 Data Signal Line
18 and 19 Characteristics
20 Block
21 Line Memory
51 Subpixel
101 and 102 Display Device
ELVDD First Power Supply
ELVSS Second Power Supply

1. (canceled)

2. A display device, comprising:
a plurality of subpixels each including a light-emitting element;
a first power supply unit and a second power supply unit electrically connected to each of the subpixels; and
a control unit configured to obtain, at time intervals, degradation information on the plurality of subpixels, and (1) to set a data signal to be supplied to each of the subpixels in accordance with the degradation information and (2) to determine, from the degradation information, presence or absence of a short circuit between the first power supply unit and the second power supply unit,
wherein the control unit calculates, for each of the subpixels, a difference between a degradation level indicated in current degradation information and a degradation level indicated in past degradation information, and detects an abnormal subpixel for which the difference exceeds a threshold value.

3. The display device according to claim 2,
wherein if a total number of abnormal subpixels exceeds a first reference value, the presence of the short circuit is determined.

4. The display device according to claim 2,
wherein the plurality of subpixels are arranged over a plurality of blocks, and
if a number of abnormal subpixels in the blocks exceeds a second reference value, the presence of the short circuit is determined.

5. The display device according to claim 2,
wherein the control unit determines the presence or absence of the short circuit, every time obtaining degradation information on a predetermined number of subpixels among the plurality of subpixels.

6. The display device according to claim 2,
wherein each of the subpixels includes a first transistor connecting to the light-emitting element, and
the degradation level is a shift amount of an ON voltage of the first transistor.

7. (canceled)

8. (canceled)

9. (canceled)

10. The display device according to claim 6, further comprising
a plurality of data signal lines,
wherein each of the subpixels includes a second transistor connected to the first transistor and to one of the plurality of data signal lines.

11. The display device according to claim 10,
wherein the first transistor is connected to the first power supply unit.

12. The display device according to claim 10,
wherein the control unit calculates the shift amount from a sensing current flowing from the second transistor to one of the plurality of data signal lines.

13. The display device according to claim 2,
wherein the control unit calculates, for each of the subpixels, a difference between a degradation level indicated in present degradation information and a degradation level indicated in previous degradation information, and
the threshold value is 0.5 to 2 times the degradation level indicated in the previous degradation information.

14. The display device according to claim 2,
wherein the first power supply unit is supplied with a high-potential power and the second power supply unit is supplied with a low-potential power.

15. The display device according to claim 14,
wherein, if the presence of the short circuit is determined, the control unit stops supplying at least one of the high-potential power or the low-potential power.
